(19) United States
(12) Patent Application Publication
(10) Pub. No.: US 2011/0111087 A1
(43) Pub. Date: May 12, 2011

(54) FOOD AND BEVERAGE SUPPLEMENT

(76) Inventors: Roberto Crea, San Mateo, CA (US); Francesco Matteuzzi, San Gimignano (IT); Stefano Astore, Capalbio (IT); Ivano Milioni, Montalto de Castro (IT)

(21) Appl. No.: 12/675,459

(22) PCT Filed: Aug. 29, 2008
(86) PCT No.: PCT/US08/10277

§ 371 Date: Jan. 13, 2011

Related U.S. Application Data
(60) Provisional application No. 60/968,742, filed on Aug. 29, 2007.

(51) Int. Cl. C11B 5/00; C12G 1/00; C12G 1/12

(52) U.S. Cl. 426/15; 426/541

(57) ABSTRACT

Compositions obtained from vegetation water from olives as an additive and methods for using the compositions as an antibacterial and/or antioxidant are described. Included are olive-derived biophenol and hydroxytyrosol-rich compounds.

### TECHNICAL FIELD

Compositions and methods for preventing oxidation in a food or beverage that is normally inhibited by the addition of sulfites are described as well as improved foods and beverages obtained with the composition.

### BACKGROUND

Sulfites are sulfur-based compounds that are often used as preservatives, anti-oxidants, or enhancers in beverages such as wine, in dried fruits, and potato products. Sulfites may further be naturally present in many foods. However, the FDA estimates that one out of 100 people are sensitive or allergic to sulfites, with an estimated 5% of these being asthmatics. In 1986, the FDA banned the use of sulfites on most fruits and vegetables that are consumed raw. Further, the FDA requires labeling of packaged foods with sulfites present in concentrations of at least 10 ppm. Sulfite sensitivity can manifest as a burning sensation, hives, cramps, diarrhea, nausea, and asthmatic episodes.

### BRIEF SUMMARY

The following aspects and embodiments thereof described and illustrated below are meant to be exemplary and illustrative, not limiting in scope.

In one aspect, an improved method for producing a beverage, such as, but not limited to, wine, containing components that are subject to undesired oxidation, and in which such oxidation is normally inhibited by the addition to the beverage of a sulfite at a concentration of between 10 and 350 mg/l, is described. The method comprises substituting for at least a portion of the sulfite in the beverage, a biophenol such that the total sulfite in the beverage is less than about 40 ppm. In an embodiment, the final concentration of biophenol is between about 1 mg to about 100 mg per liter of beverage.

In one embodiment, the biophenol is a hydroxytyrosol-rich composition. In another embodiment, the hydroxytyrosol-rich composition added to the beverage contains an amount of hydroxytyrosol, expressed as a percentage of solid material, of at least about 0.5 percent. In a further embodiment, the hydroxytyrosol-rich composition is produced by extraction of vegetative water from olives, and incubation of the vegetative water under acid conditions until the desired weight percent of hydroxytyrosol is achieved.

In an embodiment, the beverage is a red wine and the hydroxytyrosol-rich composition is added to a final hydroxytyrosol concentration of between about 1 and about 50 mg per liter of wine. In an alternative embodiment, the beverage is a white wine and the hydroxytyrosol-rich composition is added to a final hydroxytyrosol concentration of between about 1 and about 100 mg/liter of wine.

In an embodiment, the beverage is wine produced by fermentation of grapes, and the hydroxytyrosol-rich composition is added to the beverage before, and/or after such fermentation.

In another embodiment, the beverage without added sulfites contains less than about 30 ppm of sulfites.

In another aspect, an improved beverage such as wine, containing components that are subject to undesired oxidation and in which such oxidation is normally inhibited by the presence in the beverage of a sulfite at a sulfite concentration of between about 10 mg/l and about 350 mg/l, is described. The improved beverage comprises a biophenol such as hydroxytyrosol at a concentration in the beverage of between about 1 mg to about 100 mg hydroxytyrosol per liter of beverage; and an amount of sulfite that is less than about 20 ppm.

In an embodiment, hydroxytyrosol is added as a hydroxytyrosol-rich composition containing an amount of hydroxytyrosol, expressed as a percentage of solid material, of at least about 40% percent of the total phenols and/or polyphenols of the composition.

In another embodiment, the hydroxytyrosol composition added to the beverage is produced by extraction of vegetative water from olives, and incubation of the vegetative water under acid conditions until the desired weight percent of hydroxytyrosol is achieved.

In one embodiment, the beverage is a red wine having a final hydroxytyrosol concentration of between about 1 and about 50 mg per liter of wine. In an alternative embodiment, the beverage is a white wine having a final hydroxytyrosol concentration of between about 1 mg and about 100 mg per liter of wine.

Other objects, features and advantages of the compositions and methods of the present invention will be apparent from the following detailed description. It should be understood, however, that the detailed description and the specific examples provided herein, while indicating specific embodiments, are given by way of illustration only, since various changes and modifications within the spirit and scope of the invention will be apparent to those skilled in the art based upon the teachings in this detailed description.

### BRIEF DESCRIPTION OF DRAWINGS

FIG. 1A is a flow diagram of an exemplary method of making red wine.

FIG. 1B is a flow diagram of an exemplary method of making white wine.

FIG. 2 is an HPLC chromatogram of an exemplary biophenol composition.

FIGS. 3A-3B are HPLC chromatograms of red wine with added biophenol composition after two and three years of storage, respectively.

FIGS. 4A-4B are HPLC chromatograms of red wine with added sulfites after two and three years of storage, respectively.

FIGS. 5A-5B are HPLC chromatograms of white wine with added biophenol composition or sulfites, respectively, after two years of storage.

FIG. 6 is a HPLC chromatogram of white wine with biophenol composition added immediately prior to analysis.

### DETAILED DESCRIPTION

As used in this specification and the appended claims, the singular forms “a,” “an” and “the” include plural referents unless the context clearly dictates otherwise.

The following terms have the definitions given herein, unless indicated otherwise.

By “hydroxytyrosol” is intended 3,4-dihydroxyphenethyl alcohol.

By “sulfites” it is intended to refer to any of a number of sulfur based compounds, including sulfur dioxide, sodium sulfite, sodium bisulfite, potassium bisulfite, sodium metabisulfite, and potassium metabisulfite.

By “biophenol” it is intended to refer to any naturally occurring phenolic compound including one or more phenolic groups per molecule. Non-limiting exemplary biophenols include oleuropein and hydroxytyrosol. Biophenolic compositions are intended to include one or more phenolic compounds.

“Polyphenolic” refers to a compound having more than one phenol group per molecule, such as resveratrol, and/or multiple phenolic components such as hydroxytyrosol.

All publications, patents, patent applications or other references cited in this application are herein incorporated by reference in their entirety as if each individual publication, patent, patent application or reference are specifically and individually indicated to be incorporated by reference.

### Composition

In one aspect, the invention includes a biophenolic composition such as a hydroxytyrosol composition for substituting added sulfites in a food or beverage. One benefit of the added composition is to prevent undesired oxidation.

### Biophenol Composition

In an exemplary embodiment, the composition is obtained from vegetation water from olives. The olives may be obtained from conventional and commercially available sources such as growers. Preferably, the vegetation water is obtained from pitted olives. Pits in the olives contain tyrosol which is generally an undesired component in the vegetation water and which may not be appreciably broken down by the acid treatment described with reference to the hydroxytyrosol composition described further below. The pits may be separated from the pulp manually or in an automated manner as described below. Preferably, such means should be capable of segregating the pits without breaking them, which might otherwise cause higher concentrations of tyrosol in the vegetation water. In another embodiment, the vegetation water is obtained from olives that have not been pitted.

To produce vegetation water, olive pulp from the olives is first pressed to obtain a liquid-phase mixture including olive oil, vegetation water, and solid by-products. Thereafter, the vegetation water is separated from the rest of the liquid phase mixture and collected. Exemplary methods of obtaining vegetation water are described in co-owned U.S. Pat. Nos. 6,165,475 and 6,197,308, both of which are expressly incorporated herein by reference in their entirety.

For purposes of commercial production, it may be desirable to automate various aspects of the invention. In this regard, one embodiment contemplates the use of an apparatus as disclosed in U.S. Pat. Nos. 4,452,744, 4,522,119 and 4,370,274, each to Finch et al., and each expressly incorporated herein by reference. Briefly, Finch et al. teach an apparatus for recovering olive oil from olives. Initially, olives are fed to a pulper that separates the olive pits from the olives to obtain a pitless olive meat. The meat is then taken up by an extraction screw that subjects the meat to an extraction pressure sufficient to withdraw a liquid phase, comprising oil, water and a minor proportion of olive pulp. The liquid phase is collected in a bin and then sent to a clarifying centrifuge that separates the pulp from the liquid phase to obtain a mixture comprising olive oil and vegetation water. A purifying centrifuge may be used to separate the vegetation water and a small proportion of solid matter from the mixture.

Additional devices that may be used in practicing the present invention are disclosed in Italian Patent Nos. 1276576 and 1278025, each of which is expressly incorporated herein by reference. As above, these devices can be used to separate the pulp from the pits prior to processing of the crushed olive pulp into oil, water, and solid residues.

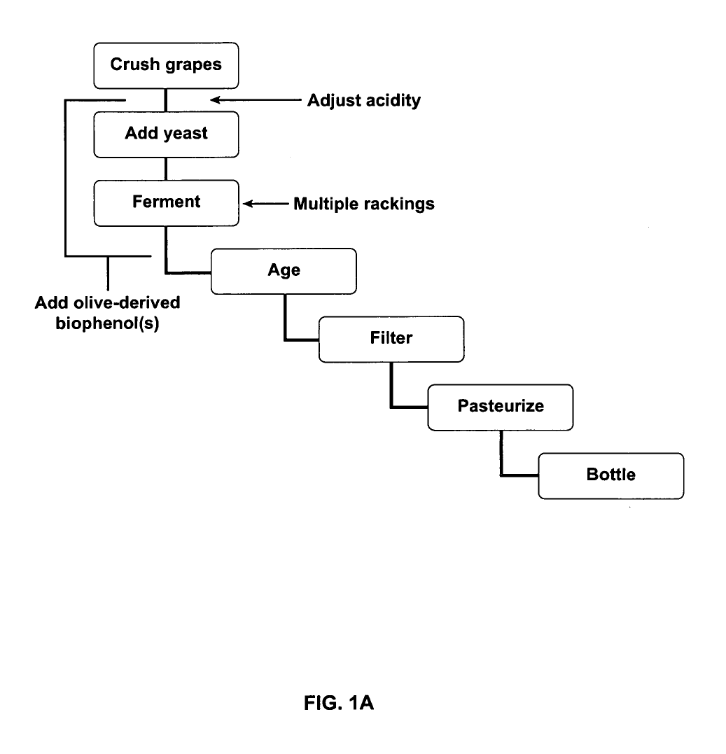

As described above, the vegetation water is rich in water-soluble phenolic compounds. Olive pulp extract generally contains about 6-9% total phenolic compounds. The phenolic compounds and their precursors detected in olive oil are ligstroside; oleuropein glucoside; aglycone of ligstroside; aglycone of oleuropein glucoside; dialdehydic form of ligstroside aglycone lacking a carboxymethyl group; dialdehydic form of oleuropein glucoside aglycone lacking a carboxymethyl group; tyrosol; and hydroxytyrosol as shown in FIG. 1 of U.S. Pat. No. 6,416,808, which is incorporated herein by reference. Hydroxytyrosol comprises about 40-50% of the total phenolic compounds in the olive pulp solid extract. It will be appreciated that the composition may include one, several, or all of the phenolic compositions in varying ratios. It will further be appreciated that the vegetation water composition may be formulated to comprise a desired amount and/or ratio of any combination of the phenolic compounds. It will also be appreciated that the active ingredient may be another component of the vegetation water acting alone or in combination with one or more of the phenolic compounds present.

### Conversion of Oleuropein to Hydroxytyrosol

In a preferred embodiment, the composition is a hydroxytyrosol-rich composition. In one exemplary embodiment, at least a portion of the oleuropein contained in the vegetation water is converted to hydroxytyrosol to produce the hydroxytyrosol-rich composition. In one embodiment, as described in co-owned U.S. Pat. No. 6,416,808 and U.S. Application No. 2003/0108651, the pH of the vegetation water may be decreased by the addition of acid, and the vegetation water be allowed to incubate under conditions which promote acid hydrolysis of oleuropein to hydroxytyrosol. The sample may then be fractionated or extracted to separate hydroxytyrosol from other compounds.

The acid is added to the vegetation water preferably to adjust the pH between 1 and 5, and more preferably to adjust the pH between 2 and 4. In a preferred embodiment, citric acid is used to adjust the pH of the vegetation water. Solid citric acid can be added while continuously stirring in an amount of preferably about 10 to 20 kg of acid per about 1000 liters of vegetation water. The pH of the resulting solution can be monitored, and the pH adjusted accordingly such as by addition of more acid to achieve and maintain the desired pH.

In other embodiments, the acid may be an organic or inorganic acid other than citric acid. Exemplary acids include the inorganic substances known as the mineral acids: sulfuric, nitric, hydrochloric, and phosphoric acids—and the organic compounds belonging to the carboxylic acid, sulfonic acid, and phenol (benzyl) groups. Without being limited as to theory, the addition of acid to the vegetation water appears to serve several purposes: (i) it stabilizes the vegetation water from air (oxygen) polymerization of phenolic molecules; (ii) it attenuates fermentation of the vegetation water by endogenous and/or exogenous bacteria and yeast; and (iii) it provides for the hydrolysis of oleuropein and other large phenolic molecules and conversion of such into hydroxytyrosol. In one embodiment, the mixture is allowed to incubate until hydroxytyrosol is 75-90% of the total combination of oleuropein and hydroxytyrosol. In another embodiment, substantially all of the oleuropein in the original mixture is converted to hydroxytyrosol.

### Purification of Hydroxytyrosol

Following the conversion of oleuropein to hydroxytyrosol, the incubated vegetation water may be purified or fractionated by any suitable method known in the art. Exemplary methods of fractionation include partitioning with an organic solvent, such as ethyl acetate, chromatographic methods, including gel chromatography and high pressure liquid chromatography (HPLC), or liquid extraction with supercritical fluids such as carbon dioxide. In other embodiments, the supercritical fluid is selected from methane, ethane, propane, butane, isobutane, ethene, propene, hydrofluorocarbons, tetrafluoromethane, chlorodifluoromethane, dinitrogen monoxide, sulphur hexafluoride, ammonia, and methyl chloride. It will be appreciated that more than one supercritical fluid may be used in combination.

Prior to extraction with a supercritical fluid the vegetation water may have carriers such as maltodextrin and/or polypropylene beads, added to the solution. Additional purification methods may also be used in accordance with the invention as mentioned above. HPLC isolation of hydroxytyrosol is described in Ficarra et al., 1991; Romani et al., 1999; and Tsimidou, 1992, each of which is expressly incorporated by reference herein.

In another embodiment, the solution may be dried prior or following extraction or purification of the desired polyphenol. The drying step preferably removes at least about 90%, more preferably at least about 95%, and even more preferably at least about 98% of the water from the vegetation water.

In one embodiment, vegetation water is obtained as described above and acidified to provide a solution which is rich in low molecular weight simple phenols and polyphenols, particularly hydroxytyrosol. In one embodiment, the vegetation water is selectively enriched for hydroxytyrosol without the presence of other components. Thus, the major biophenolic component, hydroxytyrosol, is isolated or enriched from other members of the polyphenolic family, impurities, suspended solids, tannins, and other molecules contained in the vegetation water.

In a further embodiment, the composition is an olive-derived biophenol composition. In yet another embodiment, the composition is comprised of substantially pure or pure hydroxytyrosol.

### Method of Preventing Oxidation

Oxidation is the reaction of oxygen with a compound. In fruits and vegetables, oxidation is caused by enzymatic browning, which is oxidation of pigments in the fruit/vegetables. Sulfites are regularly used to prevent or reduce discoloration or browning of fruits and vegetables from oxidation, prevent melanosis (black spots) on crustaceans such as shrimp, inhibit or prevent bacterial growth in fermented beverages such as wine and beer, and condition dough. Additionally, sulfites are present naturally in many foods such as grapes. Reference to “sulfites” includes sulfur dioxide, sodium sulfite, sodium bisulfite, potassium bisulfite, sodium metabisulfite, and potassium metabisulfite, which are all dry chemical forms of sulfur dioxide.

A variety of foods and beverages contain added sufites, including but not limited to baked goods containing dough conditioners, dried soup mixes, herbs and spices, and fruit, condiments, especially pickled condiments such as pickles, olives, and relish, canned fruits and vegetables, jams and jellies, crackers, tortilla chips, and potato chips, and fermented beverages such as beer and wine.

Sulfites are also used to prevent growth of microorganisms.

The present method is especially useful in preventing or reducing oxidation in foods and beverages where oxidation is normally inhibited or reduced by the addition of sulfites. In the method, addition of sulfites is replaced by addition of a hydroxytyrosol-rich composition, which serves to prevent or reduce oxidation.

In one preferred embodiment, the method is used to produce a beverage without added sulfites. Preferably, the hydroxytyrosol composition is added to the beverage to a final concentration of between about 1 mg to 1 gram of hydroxytyrosol per liter of beverage. In another embodiment, the hydroxytyrosol composition is added to the beverage to a concentration of 0.18 to 60 mg of total polyphenols. For beverage applications, the method may include a step of removing suspended particles. This can be effected by any method known in the art including, but not limited to, ultracentrifugation and filtering of the solution.

In a particularly preferred embodiment, the beverage is a wine. Sulfites are normally added to wine at a concentration of between 20 ppm and 50 ppm or more to prevent oxidation and prevent microorganism growth. In the United States, wines using sulfites can contain up to 350 ppm of sulfites. Also, sulfites are a natural byproduct of the fermentation process. Fermenting yeasts produce SO₂ from the naturally occurring inorganic sulfates in the grapes. In order to reduce the problems associated with added sulfites, some wine-makers make wines without added sulfites. Additionally, organic wines typically are made little or no added sulfites. American and European organic wines are limited to the use of sulfites up to 100 ppm. However, most organic wines contain less than 40 ppm of sulfites. A problem with these organic and other low sulfite wines is that they have a short shelf life. These wines may also have unusual aromas due to the presence of aldehydes that are bound by the sulfites in wines with added sulfites.

In a particularly preferred embodiment, the beverage is red or white wine. The method comprises harvesting the grapes, crushing the grapes, optionally removing the skins for white wines, fermenting the grapes, pressing the fermented grapes, aging the fermented solution, racking the solution to remove settled yeast, fining to remove excess protein or tannin, cold stabilization, filtering, and bottling. It will be appreciated that these steps may be performed in various order that will be appreciated by the skilled artisan. It will further be appreciated that some of these steps may be eliminated based on whether the beverage is a red or white wine. The olive-derived biophenol or hydroxytyrosol composition can be added before, during, and/or after fermentation of the grapes.

In one preferred embodiment, the olive-derived biophenol composition is added to wine or the winemaking process to a final concentration of between about 1 mg to about 100 mg per liter.

In another embodiment, where the wine is a red wine, the olive-derived biophenol composition is added to the wine or winemaking process to a final hydroxytyrosol concentration of between about 1 to about 50 mg per liter. In the embodiment where the wine is a white wine, the olive-derived biophenol composition is added to the wine or winemaking process to a final hydroxytyrosol concentration of between about 1 to about 100 mg per liter. In this manner, a wine without added sulfites is prepared that has the oxidation protection of a wine with added sulfites.

As described in Example 1, red wines were made using a hydroxytyrosol composition and without added sulfites. The ORAC_{hydro} for the hydroxytyrosol was measured for the wine after one, two, and three years of storage to determine the duration of oxidative protection afforded by the hydroxytyrosol. The ORAC for a red wine with added sulfites was also measured after two years of storage for comparison. As seen in the table, the red wine with the hydroxytyrosol composition had a higher ORAC, and thus antioxidant, value than the wine with added sulfites after two years of storage. Further, the hydroxytyrosol was stable for each of the one, two, and three year measurements as evidenced by the increase in ORAC. Wine with added hydroxytyrosol rather than sulfites at least retain antioxidant activity and may even have an increase in antioxidant activity as seen in the table.

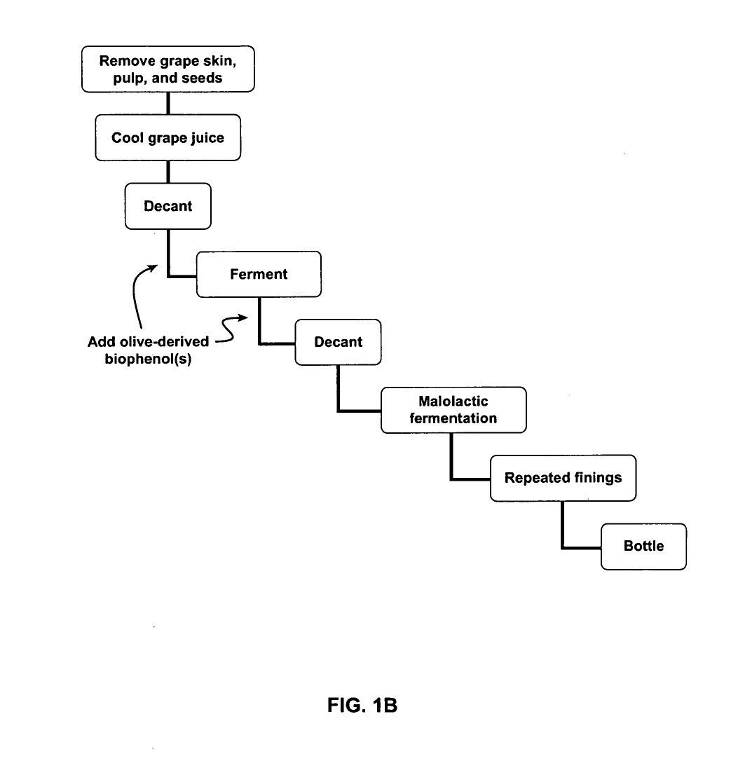

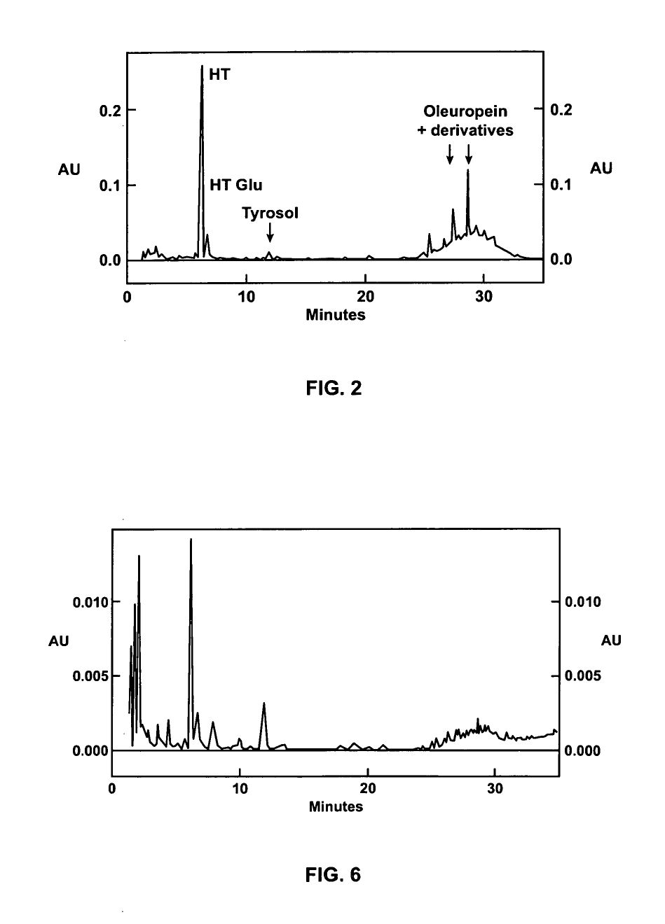

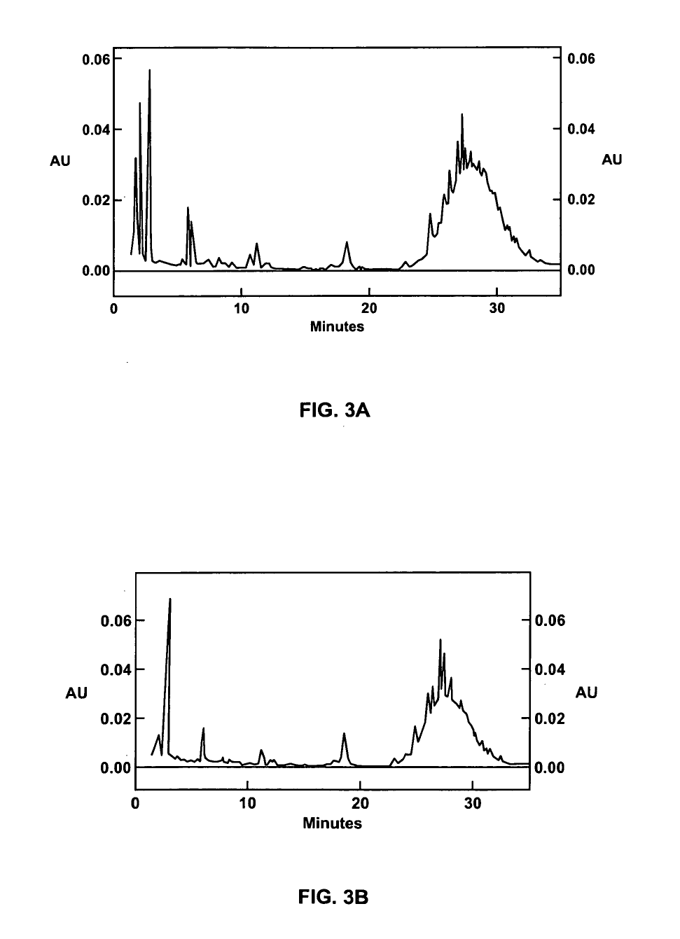

As described in Example 2, the biophenol treated wine and the sulfite treated wines were analyzed by HPLC after about two and three years of storage in the bottle. The chromatograms of the biophenol treated wines are shown in FIGS. 3A-3B for wine stored for two and three years, respectively. Chromatograms for the sulfite treated wines after about two and three years of storage in the bottle are shown in FIGS. 4A-4B, respectively. The chromatogram for the biophenol composition is shown in FIG. 2.

As seen in FIG. 4A, the chromatogram for the biophenol treated wine shows peaks at 5.850, which corresponds to hydroxytyrosol, at 11.117, which corresponds to tyrosol, and at around 26-27 minutes, which corresponds to oleuropein. An additional peak at 18.167 may indicate a partial conversion of the biophenols in the composition into other derivatives. This chromatogram corresponds to approximately 15 months from the addition of the biophenol composition to the wine to the HPLC analysis.

Similarly, as seen in FIG. 4B, the chromatogram for the biophenol treated wine shows peaks at Rt. 5.867 corresponding to hydroxytyrosol, Rt. 12.00 corresponding to tyrosol, and two peaks around 27-28 minutes, which are possibly oleuropein and oleuropein derivatives. This chromatogram corresponds to approximately 13 months from the addition of the biophenol composition to the wine to the HPLC analysis.

For comparison, the HPLC data for the biophenol composition at a concentration of 30 mg/ml is shown in FIG. 2. The HPLC profile of the biophenol composition shows significant peaks at Rt. 6.117 minutes corresponding to hydroxytyrosol, at 6.717 minutes corresponding to hydroxytyrosol glucose, and at 11.817 corresponding to tyrosol. In addition, the large molecular weight polyphenols are visible around Rt. 25 to 34 minutes. Oleuropein can be seen at Rt. 28.683 minutes.

In comparison, chromatograms for the sulfite treated wines after similar storage to the biophenol treated wines are shown in FIGS. 4A-4B. After approximately three years of storage, the sulfite treated wine showed a major peak at Rt. 2.883, a peak at 6.050, a peak at 11.533, a peak at 18.200, and a peak at 19.917. In addition, the presence of high molecular weight polyphenols is visible between 25 and 34 minutes. After approximately two years of storage, the sulfite treated wine was similar to the sulfite wine after three years. As seen in FIG. 4B, the profile shows a peak at 6.617, a peak at 8.000, a peak at 13.250, a peak at 24-25, and a peak at 27-28 min.

These profiles confirm that the added biophenols are still present in the final product after extended, that is at least two or three years, of storage.

Additionally, white wine was made using a hydroxytyrosol composition and without added sulfites as detailed in Example 3. The ORAC_{hydro} for the hydroxytyrosol was measured for the wine after one and two years of storage to determine the duration of oxidative protection afforded by the hydroxytyrosol. The ORAC for a white wine with added sulfites was also measured after two years of storage for comparison. As seen in the table, the white wine with the hydroxytyrosol composition had a higher ORAC, and thus antioxidant, value than the wine with added sulfites after two years of storage. Further, the hydroxytyrosol was stable for each of the one and two year measurements as evidenced by the increase in ORAC. Wine with added hydroxytyrosol rather than sulfites at least retains antioxidant activity.

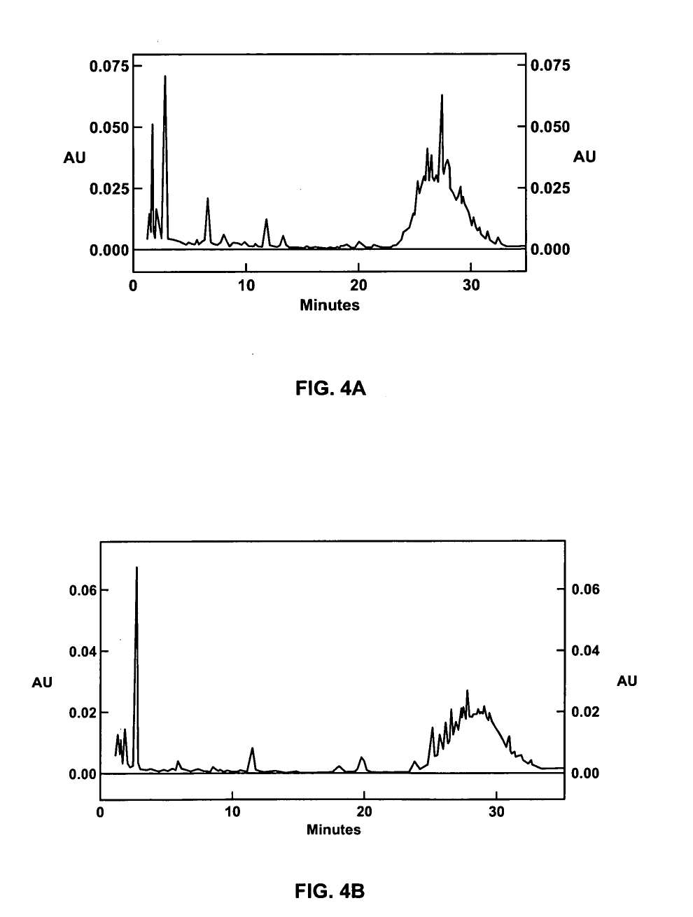

As described in Example 4, white wines with biophenols, and without added biophenols and with sulfites were analyzed by HPLC. As seen in FIG. 5B, the chromatogram for sulfite treated wine shows numerous peaks between 1.467 minutes and 35 minutes. The chromatogram also shows a group of peaks between 1.467 and 4.367, a peak at 6.667, a peak at 3 7.900, and a peak at 11.700. Also seen are modest peaks Rt. around 25-30 minutes (high molecular weights).

In contrast, and as seen in FIG. 5A, the HPLC profile for the biophenol treated wine clearly indicates that there are major differences between the sulfite treated wine and the biophenol treated wine. This is evidenced by the presence of a new peak at 6.100 (corresponding to hydroxytyrosol) and a percentage increase of the peak at 6.600. In addition, the presence of high molecular weight polyphenols is supported by the new peaks around 27-29 minutes. This analysis was performed approximately 15 months after addition of the biophenol composition to the wine.

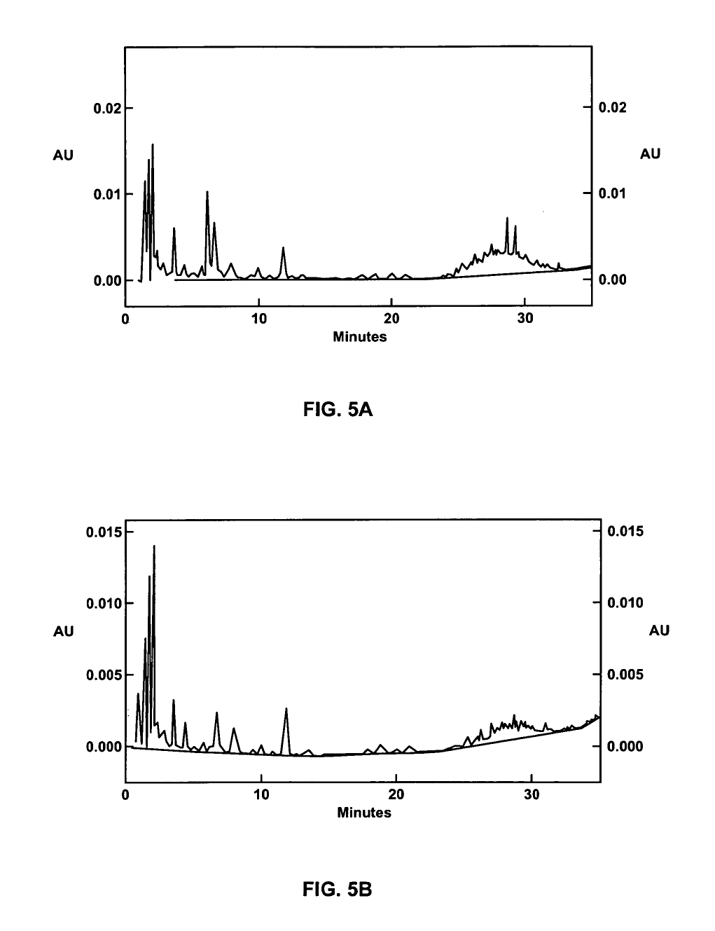

For further comparison, as described in Example 5, a biophenol composition comprising 0.03 mg/ml of hydroxytyrosol was added to wine prepared with added sulfites and analyzed by HPLC with the results shown in FIG. 6. The HPLC chromatogram shows the presence of hydroxytyrosol (Rt. at 6.133) and hydroxytyrosol glucose (Rt. at 6.667). The area of hydroxytyrosol relative to the other peaks in FIG. 5B, for example the peak at 7.9 and the peak at Rt. 11.7, seems to indicate that some portion of hydroxytyrosol is used or converted during the course of wine aging (15 months from the addition).

The HPLC chromatograms indicate that the addition of a biophenol composition to white wine alters the profile of the original wine, as expected. As further indicated, the phenol components of the biophenol composition are not consumed in the course of at least one to three years of storage as evidenced by the presence of hydroxytyrosol and oleuropein are present in the wine after 15 months from addition of the biophenol composition.

Thus, it is clear that hydroxytyrosol and other olive-derived biophenols are stable and persistent in the wine environment and therefore offer immediate as well as extended antioxidant protection. The presence of these biophenols may further provide important function for (a) the aging of the wine, (b) antibacterial activity with reduction of sulfites, and (3) all the shown health benefits of olive derived biophenols.

### EXAMPLES

The following examples are illustrative in nature and are in no way intended to be limiting.

Oxygen Radical Absorbance Capacity (ORAC) is an assay used to measure the antioxidant capacity. The assay measures the oxidative degradation of fluorescein after being mixed with peroxyl radical in the presence of trolox, a vitamin E analogue as a standard antioxidant, as well as in the presence of the sample being tested. The fluorescent intensity of the fluorescein decreases as it gets oxidized; however, the presence of antioxidants decreases the oxidative decay of fluorescein. The decay curve is graphed as fluorescent intensity over time and the area under the curve is calculated to produce the ORAC value.

### Example 1

### Production of Red Wine

Red wine was made without added sulfites and using a hydroxytyrosol-rich composition. Whole grapes of the Cabernet Sauvignon variety were crushed, de-stemmed, and placed in a stainless steel fermentor. The acidity of the grape juice was tested and adjusted to about 5.5 to about 6.5 g/liter. Activated yeast was then added to the fermentor and the solution was allowed to ferment at controlled temperature, ranging between 25 and 30° C. until most of the yeast cells and fine suspended material settled out, that is for 15 to 20 days. During this period of time, numerous rackings were executed to extract the high amount of sugars, natural polyphenol antioxidants, anthocyanins, etc. After the fermentation was completed and separation of the skin was accomplished, 2 grams of dried biophenol composition was added for each 2.5 liters of fermented solution to a final concentration of 0.8 g/liter. The composition contained about 6% total polyphenols with 1 g containing about 60 mg of total polyphenols. Of the total polyphenols, about 50% was hydroxytyrosol. Thus, 2 grams of the hydroxytyrosol-rich composition comprised about 60 mg of hydroxytyrosol and 120 mg total polyphenols. The resulting wine had a concentration of 48 mg/liter of total polyphenols and 24-30 mg/liter (0.024-0.03 mg/ml) of hydroxytyrosol.

The wine was then filtered without disturbing the sediment or the yeast. The wine was then aged, stabilized, filtered, and pasteurized. The resulting wine was then bottled.

The water-soluble antioxidant capacity (ORAC_{hydro}) for the wine as well as the total phenolic content was measured by Brunswick Laboratories (Norton, Mass.) after one (#1), two (#2), and three (#4) years as compared to a wine after two years (#3) with added sulfite with the results shown in Table 1.

TABLE 1
ORAC analysis of red wine

| | | Storage Time | ORAC_{hydro} | Total phenolics |
|---|---|---|---|---|
| Wine | Antioxidant | (years) | (μmole TE/L)¹ | (mg/L)² |
| 1 | Hydroxytyrosol | Three | 24,015 | 1,633.98 |
| 2 | Hydroxytyrosol | Two | 32,037 | 1,943.77 |
| 3 | Sulfites | Two | 21,977 | 1,598.51 |
| 4 | Hydroxytyrosol | One | 36,995 | 2,502.38 |

¹micromole trolox equivalent (TE) per liter for the water-soluble antioxidant capacity
²Total phenolics is expressed as milligram gallic acid equivalent per liter

### Example 2

### HPLC Analysis of Red Wine

A sample of the bottled wine with added biophenols after storage for each of two or three years (see #2 and #1 in Table 1, respectively) at room temperature as described in Example 1 was withdrawn directly from the bottles and 20 μl was analyzed by HPLC. Additionally, a sample of 20 μl of the bottled wine with added sulfites after storage for two (see #3 in Table 1) or three years was also analyzed by HPLC.

The HPLC analysis was performed on a Beckman-Coulter 125NM series system consisting of a 125 NM series pump, a 166 NMP series UV detector and with an analytical Ultrasphere reverse phase column (C-18; 150×4.6 mm id). Separation was achieved by running an isocratic elution for 20 minutes with a solvent made up of Solvent A (Phosphate Buffer-99.5%/) and Solvent B (100% methanol-0.5%) for 20 minutes, followed by a gradient elution where Solvent B was added to solvent A linearly at a rate necessary to achieve 100% of solvent B in 15 minutes. Phenolic compounds were measured by means of a UV detector (OD₂₈₀ nm) at room temperature. Data was collected and analyzed using Beckman 32 Karat Software. The HPLC data for the wine with added biophenols is shown in FIG. 3A for #2 and FIG. 3B for #1. HPLC data for the wine with added sulfites is shown in FIG. 4A for #3 and in FIG. 4B for the wine after three years of storage. HPLC data for the biophenol composition alone is shown in FIG. 2.

### Example 3

### Production of White Wine

White wine was made without added sulfites and using a hydroxytyrosol-rich composition. In this case, the skins, pulp, and seeds were removed from the juice of Ansonica variety grapes prior to adding yeast. The juice was quickly cooled to low temperate (4-5° C.) for 3-4 days to obtain a first sedimentation of suspended particles. The resulting fruit juice was decanted and placed in a stainless steel fermentor. Activated yeast was then added to the fermentor and the solution was allowed to ferment while keeping the temperature between 15 and 16° C. for 10-15 days. After the fermentation was completed, 2 grams of a dried hydroxytyrosol-rich composition as described in Example 1 was added for each 2.5 liters of fermented solution for a concentration of 0.8 g/liter. The wine was decanted and then transferred to a clean container. By this procedure, every decantation and transfer corresponds to a fining procedure, i.e. separation from sedimented particles. In our case, as result of the absence of sulfites, the malo-lactic fermentation occurs naturally. Fining was performed once every 2-3 months for 6-9 months. The resulting wine was then bottled.

The water-soluble antioxidant capacity (ORAC_{hydro}) for the hydroxytyrosol was measured after one and two years as compared to a wine at one year with added sulfites with the results shown in Table 2.

TABLE 2
ORAC analysis of white wine

| | | Storage Time | ORAC_{hydro} | Total phenolics |
|---|---|---|---|---|
| Wine | Antioxidant | (years) | (μmole TE/L)¹ | (mg/L)² |
| 1 | Hydroxytyrosol | One | 6,745 | 376.34 |
| 2 | Hydroxytyrosol | Two | 4,859 | 201.10 |
| 3 | Sulfites | Two | 1,987 | 115.25 |

¹micromole trolox equivalent (TE) per liter
²Total phenolics is expressed as milligram gallic acid equivalent per liter

### Example 4

### HPLC Analysis of White Wine

A sample of white wine produced as described in Example 3 was withdrawn directly from the bottle after approximately two years of storage (about 15 months after addition of the biophenol) (#2 in Table 2) at 15-18° C. and 20 μl was analyzed by HPLC. Additionally, a sample of 20 μl of the bottled wine with added sulfites after storage for about two years (#3 in Table 2) was also analyzed by HPLC.

The HPLC analysis was performed on a Beckman-Coulter 125NM series system consisting of a 125 NM series pump, a 166 NMP series UV detector and with an analytical Ultrasphere reverse phase column (C-18; 150×4.6 mm id). Separation was achieved by running an isocratic elution for 20 minutes with a solvent made up of Solvent A (Phosphate Buffer-99.5%/) and Solvent B (100% methanol-0.5%) for 20 minutes, followed by a gradient elution where Solvent B was added to solvent A linearly at a rate necessary to achieve 100% of solvent B in 15 minutes. Phenolic compounds were measured by means of a UV detector (OD₂₈₀ nm) at room temperature. Data was collected and analyzed using Beckman 32 Karat Software and is shown in FIG. 5A for the biophenol treated wine. FIG. 5B shows the HPLC data for the wine with added sulfites.

### Example 5

### HPLC Analysis of White Wine with Biophenols Added After Storage

A sample of white wine (10 ml) prepared with added sulfites as described in Example 3 and stored for approximately two years was withdrawn directly from the bottle. Approximately 7.5 to 8.0 mg of a composition comprising 6% biophenols (0.03 mg/ml hydroxytyrosol) was added to the sample and 20 μl of the sample was then analyzed by HPLC.

The HPLC analysis was performed on a Beckman-Coulter 125NM series system consisting of a 125 NM series pump, a 166 NMP series UV detector and with an analytical Ultrasphere reverse phase column (C-18; 150×4.6 mm id). Separation was achieved by running an isocratic elution for 20 minutes with a solvent made up of Solvent A (Phosphate Buffer-99.5%/) and Solvent B (100% methanol-0.5%) for 20 minutes, followed by a gradient elution where Solvent B was added to solvent A linearly at a rate necessary to achieve 100% of solvent B in 15 minutes. Phenolic compounds were measured by means of a UV detector (OD₂₈₀ nm) at room temperature. Data was collected and analyzed using Beckman 32 Karat Software and is shown in FIG. 6.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. In a method for producing a beverage, such as wine, containing components that are subject to undesired oxidation, and in which such oxidation is normally inhibited by the addition to the beverage of a sulfite at a concentration of between 10 and 350 mg/l, an improvement comprising
substituting for at least a portion of the sulfite in the beverage, an olive-derived biophenol such that the total sulfite in the beverage is less than about 40 ppm.

2. The method of claim 1, where the final concentration of olive-derived biophenol is between about 1 mg to about 100 mg per liter of beverage.

3. The method of claim 1, wherein the olive-derived biophenol is a hydroxytyrosol-rich composition.

4. The improved method of claim 3, wherein the hydroxytyrosol-rich composition added to the beverage contains an amount of hydroxytyrosol, expressed as a percentage of solid material, of at least about 0.5 percent.

5. The improved method of claim 3, wherein the hydroxytyrosol-rich composition is produced by extraction of vegetative water from olives, and incubation of the vegetative water under acid conditions until the desired weight percent of hydroxytyrosol is achieved.

6. The improved method of claim 3, wherein the beverage is a red wine and the hydroxytyrosol-rich composition is added to a final hydroxytyrosol concentration of between about 1 and about 50 mg per liter of wine.

7. The improved method of claim 3, wherein the beverage is a white wine and the hydroxytyrosol-rich composition is added to a final hydroxytyrosol concentration of between about 1 and about 100 mg/liter of wine.

8. The improved method of claim 3, wherein the beverage is wine produced by fermentation of grapes, and the hydroxytyrosol-rich composition is added to the beverage before, and/or after such fermentation.

9. The improved method of claim 1, wherein the beverage contains less than about 30 ppm of sulfites.

10. An improved beverage, such as wine, containing components that are subject to undesired oxidation, and in which such oxidation is normally inhibited by the presence in the beverage of a sulfite, at a sulfite concentration of between about 10 mg/l and about 350 mg/l, an improvement comprising
hydroxytyrosol at a concentration in the beverage of between about 1 mg to about 100 mg hydroxytyrosol per liter of beverage; and
an amount of sulfite that is less than about 20 ppm.

11. The improved beverage of claim 10, wherein the hydroxytyrosol contained in the beverage is added as a hydroxytyrosol-rich composition containing an amount of hydroxytyrosol, expressed as a percentage of solid material, of at least about 40% percent of the total polyphenols of the composition.

12. The improved beverage of claim 10, wherein the hydroxytyrosol composition added to the beverage is produced by extraction of vegetative water from olives, and incubation of the vegetative water under acid conditions until the desired weight percent of hydroxytyrosol is achieved.

13. The improved beverage of claim 10, which is a red wine having a final hydroxytyrosol concentration of between about 1 and about 50 mg per liter of wine.

14. The improved beverage of claim 10, which is a white wine having a final hydroxytyrosol concentration of between about 1 mg and about 100 mg per liter of wine.
